(19) United States
(12) Patent Application Publication
(10) Pub. No.: US 2021/0061100 A1
(43) Pub. Date: Mar. 4, 2021

(54) VEHICLE-MOUNTED DISPLAY DEVICE AND AUTOMOBILE HAVING SAME

(71) Applicant: Wuhan China Star Optoelectronics Semiconductor Display Technology Co., Ltd., Wuhan, Hubei (CN)

(72) Inventors: Yang ZHOU, Wuhan, Hubei (CN); Mugyeom KIM, Wuhan, Hubei (CN)

(21) Appl. No.: 16/622,626

(22) PCT Filed: Nov. 8, 2019
(86) PCT No.: PCT/CN2019/116465

§ 371 Date: Dec. 13, 2019

(30) Foreign Application Priority Data
Aug. 26, 2019 (CN) 2001910791067.4

(51) Int. Cl. B60K 35/00

(52) U.S. Cl. CPC B60K 35/00; B60K 2370/1533; B60K 2370/779; B60K 2370/785; B60K 2370/777; B60K 2370/67

(57) ABSTRACT

The disclosure provides a vehicle-mounted display device and an automobile having same. The vehicle-mounted display device includes a first display screen and a second display screen. At least the first display screen is a flexible and foldable display screen. The first display screen includes a bending section and two non-bending sections disposed at two sides of the bending section. One of the two non-bending sections is attached to an automobile, and the other of the two non-bending sections is configured to retract or expand the first display screen by the bending section. The first display screen connects with the second display screen to form a display screen assembly after being expanded.

### FIELD

The present disclosure relates to the field of display technology and, more particularly, to a vehicle-mounted display device and an automobile having same.

### BACKGROUND

Cars are tools for people to travel with. With development of transportation, the proportion of automobiles in transportation has become increasingly greater. As a critical aspect in human-computer interaction, display devices will play an increasingly more vital role in intelligent vehicles. Display screens of traditional transportation means are statically mounted at an instrument screen of an automobile, so it is impossible to utilize a surface region of the instrument screen where the display screens occupy. The use of clean energy such as electrical energy is a future trend in transportation. However, traditional liquid crystal display devices take up too much space of the instrument screen; furthermore, the traditional liquid crystal display devices are too heavy to breakthrough a limitation of arrangement position. Therefore, a future trend is to develop a vehicle-mounted display device that has less occupied space, more flexible and convenient functions, and lower power consumption.

### SUMMARY

The present disclosure provides a vehicle-mounted display device and an automobile having same, which can solve a problem that traditional liquid crystal display devices take up too much space of the instrument screen and are too heavy to breakthrough a limitation of arrangement position.

To solve the above problem, technical solutions provided by the present disclosure are described as follows:

The present disclosure provides a vehicle-mounted display device, including a first display screen and a second display screen which are disposed individually and correspondingly. The vehicle-mounted display device is disposed in and attached to an automobile cabin, and at least the first display screen is a flexible and foldable display screen.

The first display screen includes a bending section and two non-bending sections disposed at two sides of the bending section. One of the two non-bending sections is attached to the automobile cabin, and the other of the two non-bending sections is configured to fold or expand the first display screen along the bending section.

The first display screen is configured to connect with the second display screen to form a display screen assembly after being expanded.

In the vehicle-mounted display device provided by the present disclosure, the first display screen includes a protective housing and a display panel disposed in the protective housing. Each end of the two non-bending sections of the first display screen away from the bending section is provided with a reel disposed in the protective housing. Two ends of the reel are attached to the protective housing. The display screen includes an extended section. The reel is configured to retract or expand the extended section of the display panel.

In the vehicle-mounted display device provided by the present disclosure, an elastic member is further disposed in the protective housing, and an end of the elastic member is connected to the extended section of the display panel.

In the vehicle-mounted display device provided by the present disclosure, the protective housing includes two rigid sections corresponding to the two non-bending sections and a flexible section corresponding to the bending section. Each end of the two rigid sections away from the flexible section is provided with a rigid extended section. At least a portion of the rigid extended section is embedded in the rigid section. The reel is attached to the rigid extended section and is moved along the rigid extended section relative to a direction parallel to a plane on which the rigid section is disposed to drive the reel to rotate.

In the vehicle-mounted display device provided by the present disclosure, the rigid extended section is connected to the rigid section by a slide rail. The protective housing is provided with a lock. When the rigid extended section is moved along the slide rail, the lock is opened, while after the rigid extended section is moved to a predetermined distance, the lock is closed.

In the vehicle-mounted display device provided by the present disclosure, the automobile cabin includes a roof, a windshield, a center console, a sun visor, and a rearview mirror. The second display screen is attached to the center console. The first display screen is attached to a side of the roof near the windshield and corresponding to the second display screen. The first display screen is configured to form the display screen assembly with the second display screen after being expanded.

In the vehicle-mounted display device provided by the present disclosure, the sun visor and/or the rearview mirror is the first display screen.

In the vehicle-mounted display device provided by the present disclosure, the automobile cabin further includes a seat, the second display screen is attached to a backside of the seat. The first display screen is attached to a side of a roof corresponding to the second display screen. The first display screen is configured to form the display screen assembly with the second display screen after being expanded.

To solve the above technical problem, the present disclosure further provides an automobile with the above vehicle-mounted display device.

To solve the above problem, the present disclosure provides a vehicle-mounted display device, including a first display screen and a second display screen which are disposed individually and correspondingly. The vehicle-mounted display device is disposed in and attached to an automobile cabin, and at least the first display screen is a flexible and foldable display screen.

The first display screen includes a bending section and two non-bending sections disposed at two sides of the bending section. One of the two non-bending sections is attached to the automobile cabin, and the other of the two non-bending sections is configured to fold or expand the first display screen along the bending section.

At least one first display screen is configured to connect with at least one second display screen to form a display screen assembly after being expanded. A periphery of one of the two the non-bending sections configured to rotationally expand the first display screen is used to connect with a periphery of the second display screen near the first display screen to form the display screen assembly.

In the vehicle-mounted display device provided by the present disclosure, at least one first display screen is configured to connect with at least one second display screen to form a display screen assembly after being expanded. A periphery of one of the two the non-bending sections configured to rotationally expand the first display screen is used to connect with a periphery of the second display screen near the first display screen to form the display screen assembly.

In the vehicle-mounted display device provided by the present disclosure, the first display screen includes a protective housing and a display panel disposed in the protective housing. Each end of the two non-bending sections of the first display screen away from the bending section is provided with a reel disposed in the protective housing. Two ends of the reel are attached to the protective housing. The display screen includes an extended section. The reel is configured to retract or expand the extended section of the display panel.

In the vehicle-mounted display device provided by the present disclosure, an elastic member is further disposed in the protective housing, and an end of the elastic member is connected to the extended section of the display panel.

In the vehicle-mounted display device provided by the present disclosure, the protective housing includes two rigid sections corresponding to the two non-bending sections and a flexible section corresponding to the bending section. Each end of the two rigid sections away from the flexible section is provided with a rigid extended section. At least a portion of the rigid extended section is embedded in the rigid section. The reel is attached to the rigid extended section and is moved along the rigid extended section relative to a direction parallel to a plane on which the rigid section is disposed to drive the reel to rotate.

In the vehicle-mounted display device provided by the present disclosure, the rigid extended section is connected to the rigid section by a slide rail. The protective housing is provided with a lock. When the rigid extended section is moved along the slide rail, the lock is opened, while after the rigid extended section is moved to a predetermined distance, the lock is closed.

In the vehicle-mounted display device provided by the present disclosure, the automobile cabin includes a roof, a windshield, a center console, a sun visor, and a rearview mirror. The second display screen is attached to the center console. The first display screen is attached to a side of the roof near the windshield and corresponding to the second display screen. The first display screen is configured to form the display screen assembly with the second display screen after being expanded.

In the vehicle-mounted display device provided by the present disclosure, the sun visor and/or the rearview mirror is the first display screen.

In the vehicle-mounted display device provided by the present disclosure, the automobile cabin further includes a seat, the second display screen is attached to a backside of the seat. The first display screen is attached to a side of a roof corresponding to the second display screen. The first display screen is configured to form the display screen assembly with the second display screen after being expanded.

Regarding beneficial effects of the present disclosure: In the vehicle-mounted display device and the automobile having same provided by the present disclosure, a flexible and foldable display screen is applied to an automobile, which can significantly reduce space occupied by a display device. As a result, other devices in the automobile may have more space to be arranged. Moreover, the vehicle-mounted display device of the present disclosure may also be a sun visor or a rearview mirror of the automobile, which further conserves space. The flexible and foldable display screen has advantages such as lightweight and small volume. The flexible and foldable display screen can connect with other display devices in the automobile to form a display screen assembly having a large display area, thereby making arrangement of the vehicle-mounted display device more flexible and convenient.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which those skilled in the art can derive further figures without making any inventive efforts.

FIG. 1 is a schematic structural view showing a vehicle-mounted display device in an automobile according to an embodiment of the present disclosure.

FIG. 2 is a schematic structural view showing a flexible and foldable display screen when expanded according to an embodiment of the present disclosure.

FIG. 3 is a schematic structural view showing a display panel of the flexible and foldable display screen of FIG. 2.

FIG. 4 is a schematic view showing a portion of a flexible and foldable display screen when expanded according to an embodiment of the present disclosure.

FIG. 5 is a schematic structural view showing a reel of a flexible and foldable display screen according to an embodiment of the present disclosure.

FIG. 6 is a schematic structural view showing a flexible and foldable display screen when folded according to an embodiment of the present disclosure.

FIG. 7 is a schematic structural view showing a display panel of the flexible and foldable display screen of FIG. 6.

FIG. 8 is a schematic structural view showing a vehicle-mounted display device in an automobile according to a first embodiment of the present disclosure.

FIG. 9 is a schematic structural view showing another a vehicle-mounted display device in an automobile according to a first embodiment of the present disclosure.

FIG. 10 is a schematic structural view showing a vehicle-mounted display device in an automobile according to a second embodiment of the present disclosure.

FIG. 11 is a schematic structural view showing a vehicle-mounted display device in an automobile according to a third embodiment of the present disclosure.

### DETAILED DESCRIPTION

The following description of the various embodiments is provided with reference to the accompanying drawings. It should be understood that terms such as “upper”, “lower”, “front”, “rear”, “left”, “right”, “inside”, “outside”, “clockwise”, “lateral”, as well as derivative thereof should be construed to refer to the orientation as then described or as shown in the drawings under discussion. These relative terms are for convenience of description, do not require that the present disclosure be constructed or operated in a particular orientation, and shall not be construed as causing limitations to the present disclosure. In the drawings, the identical or similar reference numerals constantly denote the identical or similar elements or elements having the identical or similar functions.

The present disclosure can solve the problem that traditional liquid crystal display devices take up too much space of the instrument screen and are too heavy to breakthrough a limitation of arrangement position.

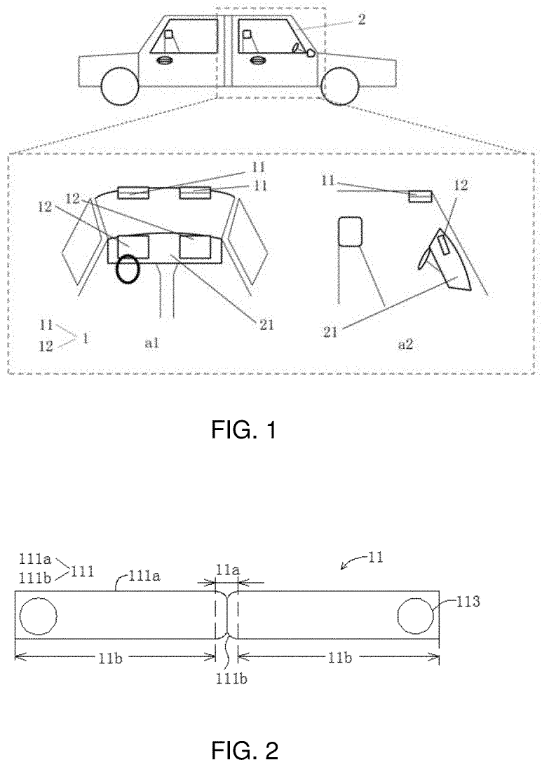

As shown in FIG. 1, which is a schematic structural view showing a vehicle-mounted display device in an automobile according to an embodiment of the present disclosure. A vehicle-mounted display device 1 is attached to and disposed in an automobile cabin 2. As shown by a1 and a2 of FIG. 1, which are respectively a front view and a side view of the vehicle-mounted display device 1 in the automobile cabin 2. The vehicle-mounted display device 1 includes a first display screen 11 and a second display screen 12 which are disposed individually and correspondingly. The second display screen 12 may be attached to a center console 21 in the automobile cabin 2, but it is not limited thereto. The second display screen 12 may be attached to other positions of the automobile cabin 2. The first display screen 11 is disposed above the second display screen 12. At least the first display screen 11 is a flexible and foldable display screen. The first display screen 11 is configured to connect with the second display screen 12 to form a display screen assembly after being expanded.

In other embodiments of the present disclosure, both the first display screen 11 and the second display screen 12 are the flexible and foldable display screens, and the first display screen 11 connects with the second display screen 12 to form the display screen assembly after being expanded.

In the following detailed description of the present embodiment, the first display screen 11 is a flexible and foldable display screen, and the second display screen 12 is a liquid crystal display screen.

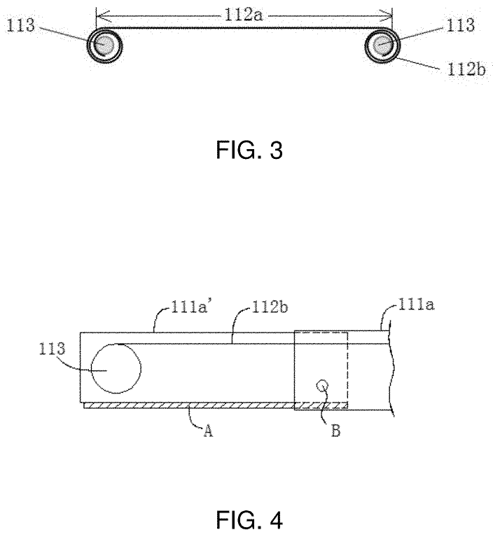

As shown in FIG. 2 and FIG. 3, the first display screen 11 includes a bending section 11a and two non-bending sections 11b disposed at two sides of the bending section 11a. One of the two non-bending sections 11b is attached to the automobile cabin 2, and the other of the two non-bending sections 11b is configured to fold or expand the first display screen 11 along the bending section 11a.

The first display screen 11 includes a protective housing 111 and a display panel 112 disposed in the protective housing 111. The protective housing 111 is configured to protect the display panel 112. Each end of the two non-bending sections 11b of the first display screen 11 away from the bending section 11a is provided with a reel 113 disposed in the protective housing 111. Two ends of the reel 113 are attached to the protective housing 111. A diameter of the reel 113 is less than a height of a chamber formed by the protective housing 111, that is, gaps with a predetermined size exist between the reel 113, a top surface of the protective housing 111, and a bottom surface of the protective housing 111.

The protective housing 111 includes two rigid sections 111a corresponding to the two non-bending sections 11b and a flexible section 111b corresponding to the bending section 11a. Structure and material of the rigid sections 111a and the flexible section 111b are not limited by the present disclosure as long as the two rigid sections 111a can be folded or expanded along the flexible section 111b.

FIG. 3 is a schematic structural view showing a display panel of the flexible and foldable display screen of FIG. 2. The display panel 112 includes a display section 112a and an extended section 112b. The reel 113 is configured to retract or expand the extended section 112b of the display panel 112. An end of the extended section 112b of the display panel 112 is connected to the reel 113. The extended section 112b also has a display function. When the first display screen 11 is expanded, the extended section 112b is wound around the reel 113. Meanwhile, the extended section 112b wound around the reel 113 is not used to display, while another portion of the display panel 112 is used to display.

As shown in FIG. 2 and FIG. 4, Each end of the two rigid sections 111a of the protective housing 111 away from the flexible section 111b is provided with a rigid extended section 111a′. Two sides of the protective housing 111 are provided with the rigid extended section 111a′, and only one of the rigid extended sections 111a′ is taken as an example here for the purpose of illustrating the present embodiment. At least a portion of the rigid extended section 111a′ is embedded in the rigid section 111a. The reel 113 is attached to the rigid extended section 111a′ and is moved along the rigid extended section 111a′ relative to a direction parallel to a plane on which the rigid section 111a is disposed to drive the reel 113 to rotate, thereby retracting or expanding the extended section 112b of the display panel 112.

When the rigid extended section 111a′ is pulled outwardly (a direction away from the flexible section 111b), the extended section 112b of the display panel 112 is expanded. Meanwhile, an area of the first display screen 11 is enlarged compared to the first display screen 11 which is unexpanded, and both the extended section 112b which is extended and the display section 112a are used to display. When the rigid extended section 111a′ is pushed inwardly (a direction toward the flexible section 111b), the extended section 112b of the display panel 112 is retracted. If the extended section 112b is completely retracted, the display section 112a is used to display, while if the extended section 112b is partially retracted, both the display section 112a and the extended section 112b which is not retracted are used to display.

The rigid extended section 111a′, the rigid section 111a, a slide rail A, and a pulley (not shown) form a sliding component to move the rigid extended section 111a′ and the rigid section 111a. However, it is not limited thereto, and other common moving ways may be used as well. By the above “drawer type” design, when people require the first display screen 11 with small occupied space, they can retract the rigid extended section 111a′ into the rigid section 111a, and then fold the first display screen 11. On the other hand, when people need a large display area, they can pull out the rigid extended section 111a′ to realize a large-scale display.

Furthermore, the protective housing 111 is provided with a lock B. When the rigid extended section 111a′ is moved along the slide rail A, the lock B is opened. After the rigid extended section 111a′ is moved to a predetermined distance, the lock B is closed. As a result, the rigid extended section 111a′ and the rigid section 111a can be fixed, thereby preventing the rigid extended section 111a′ from moving.

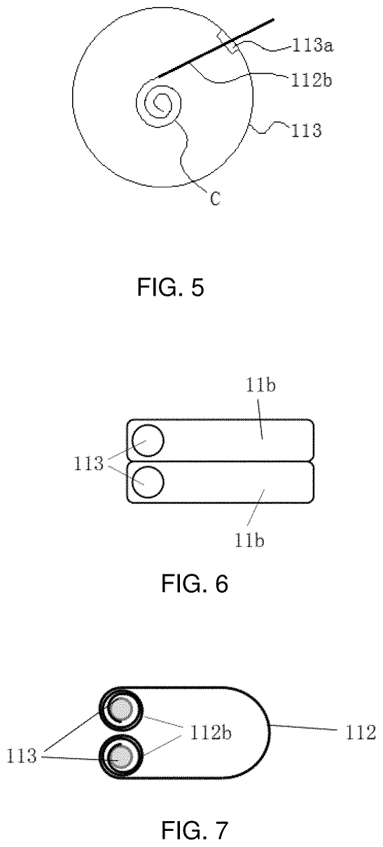

In another embodiment, an elastic member C is further disposed in and attached to the protective housing 111, and an end of the elastic member C is connected to the extended section 112b of the display panel 112. For example, as shown in FIG. 5, the reel 113 is a cavity structure, a recessed section 113a is defined in a surface of the reel 113, and the elastic member C is disposed in the reel 113. An end of the extended section 112b is attached to an end of the elastic member C by the recessed section 113a, and the other end of the elastic member C is attached to the reel 113. Pre-tension exists between the elastic member C and the extended section 112b, thereby ensuring flatness of surface of the display panel 112, preventing the surface of the display panel 112 from being folded, and ensuring that the display panel 112 will not be damaged when the extended section 112b is completely expanded.

In the present embodiment, the elastic member C is a coil spring, but it is not limited thereto.

As shown in FIG. 6 and FIG. 7, FIG. 6 and FIG. 7 are schematic structural views showing the flexible and foldable display screen after being folded. The extended section 112b of the display panel 112 is retracted into the reel 113. The two non-bending sections 11b at two sides of the flexible and foldable display screen are overlapped after the flexible and foldable display screen is folded.

It should be noted that the flexible and foldable display screen can be extended whether it is folded or expanded. The flexible and foldable display screen in an extended state is as described in FIG. 4 above, which will not be described again here. The flexible and foldable display screen can also be extended when it is in a folded state (the flexible and foldable display screen is not used to display). The extending way of the flexible and foldable display screen in the folded state is similar to that of the flexible and foldable display screen in the extended state, which can be referred in the above description of FIG. 4.

It should be further noted that the flexible and foldable display screen may be extended on one side only, that is, only one of the two non-bending sections 11b is extended. The flexible and foldable display screen may also be extended on both two sides, that is, both of the two non-bending sections 11b are extended.

In the present disclosure, at least one first display screen 11 is connected to at least one second display screen 12 to form a display screen assembly. A periphery of one of the two the non-bending sections 11b configured to rotationally expand the first display screen 11 is used to connect with a periphery of the second display screen 12 near the first display screen 11 to form the display screen assembly.

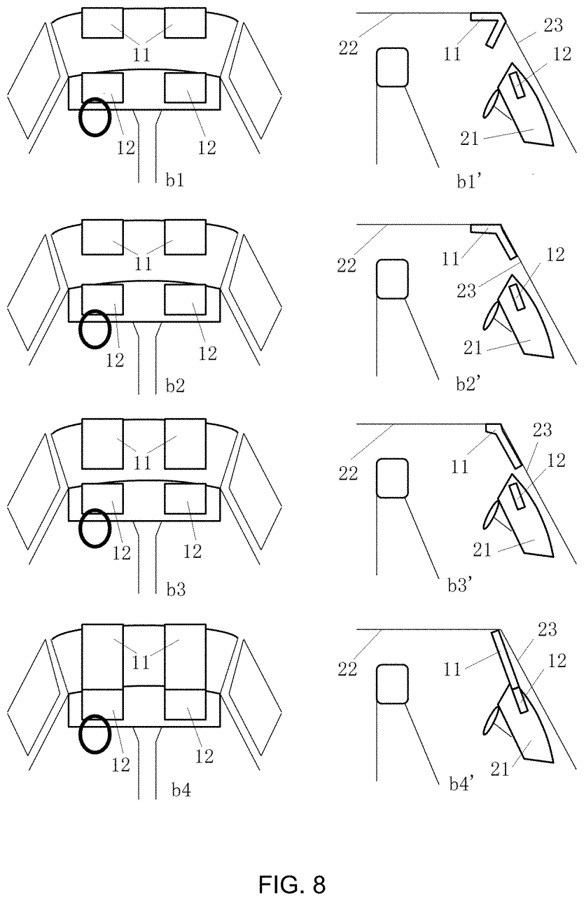

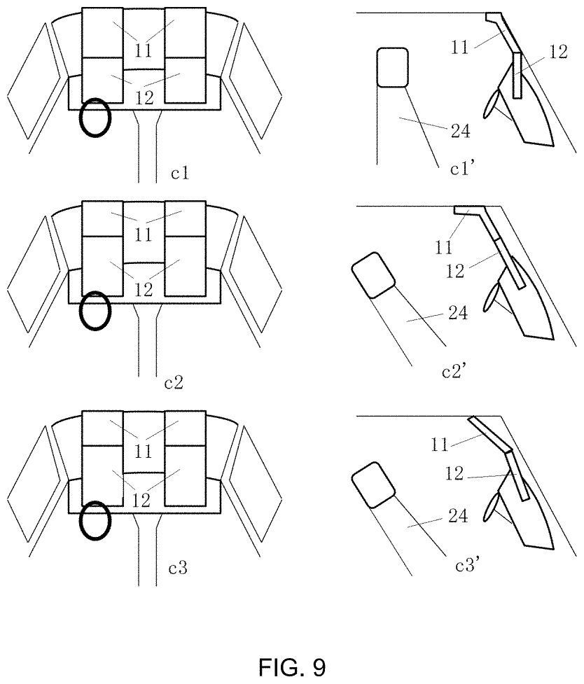

As shown in FIG. 8, FIG. 8 is a schematic structural view showing a vehicle-mounted display device in an automobile according to an embodiment of the present disclosure. The automobile cabin 2 includes but is not limited to a center console 21, a roof 22, a windshield 23, a seat 24, and a sun visor. In the following detailed descriptions, the sun visor is the first display screen 11, and the first display screen 11 is connected to the second display screen 12 disposed on the center console 21 to form the display screen assembly.

In FIG. 8, reference numbers b1 to b4 are front views of the vehicle-mounted display device in the automobile, and reference numbers b1′ to b4′ are side views of the vehicle-mounted display device in the automobile. Referring to the front view b1 and the side view b1′, areas of the two non-bending sections 11b of the first display screen 11 are equal. One of the non-bending sections 11b is integrally attached to a side of the roof 22 near the windshield 23 and corresponding to the second display screen 12, which makes the first display screen 11 and the second display screen 12 disposed on the center console 21 form the display screen assembly after the first display screen 11 is expanded from the folded state to a predetermined angle. The predetermined angle that the first display screen 11 is expanded to may be adjusted depending on shading needs, which is not limited here.

Referring to the front view b2 and the side view b2′, compared to the front view b1 and the side view b1′, the non-bending section 11b, which is configured to rotationally expand the first display screen 11, is rotated to attach to a surface of the windshield 23. The first display screen 11 connects with the second display screen 12 to form the display screen assembly.

Referring to the front view b3 and the side view b3′, areas of the two non-bending sections 11b of the first display screen 11 are different, the non-bending section 11b with a smaller area is integrally attached to the roof 22, and the non-bending section 11b with a larger area is rotationally attached to the surface of the windshield 23 and is connected to the second display screen 12 to form the display screen assembly.

Referring to the front view b4 and the side view b4′, the first display screen 11 is expanded at 180 degrees and is disposed on a same plane as the second display screen 12. A periphery of the first display screen 11 and a periphery of the second display screen 12 are connected seamlessly, thereby forming the display screen assembly.

It should be noted that in FIG. 8, the first display screen 11 may be extended on a single side or both sides depending on actual needs after being expanded.

Of course, other devices, such as a rearview mirror, may also be the first display screen 11, which is not limited here.

As shown in FIG. 9, in one embodiment, the second display screen 12 may also be moved. For example, the second display screen 12 may seamlessly connect with the first display screen 11 by adjusting a tilt angle, thereby giving a driver better viewing angles after an angle of a seat 24 is adjusted. In FIG. 9. reference numbers c1 to c3 are front views of the vehicle-mounted display device in the automobile, and reference numbers c1′ to c3′ are side views of the vehicle-mounted display device in the automobile.

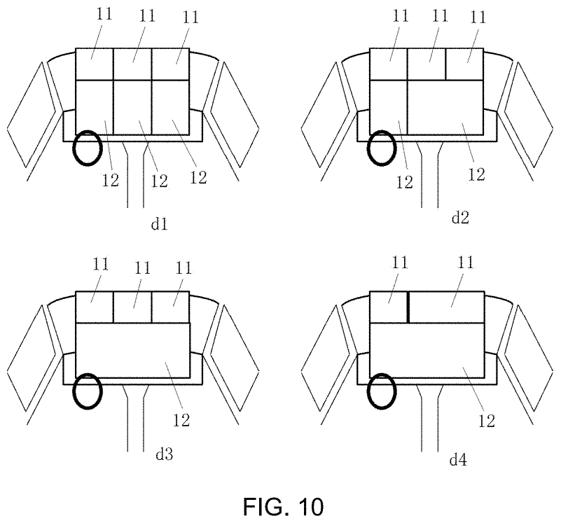

As shown in FIG. 10, FIG. 10 is a schematic structural view showing a vehicle-mounted display device in an automobile according to a second embodiment of the present disclosure. Different from the first embodiment, the connecting way in the second embodiment is multiple, which is not limited to a “one to one” connecting way but may also be a “multiple to multiple” connecting way or a “one to multiple” connecting way. The connecting way in the second embodiment may depend on different designs of display panels in the automobile. Referring to d1 to d4 in FIG. 10, one first display screen 11 may correspondingly connect with at least two second display screens 12 to form the display screen assembly, or one second display screen 12 may correspondingly connect with at least two first display screens 11 to form the display screen assembly, or the at least two first display screens 11 may connect with the at least two display screens 12 to form the display screen assembly. FIG. 10 only shows four connecting ways, but they are not limited thereto.

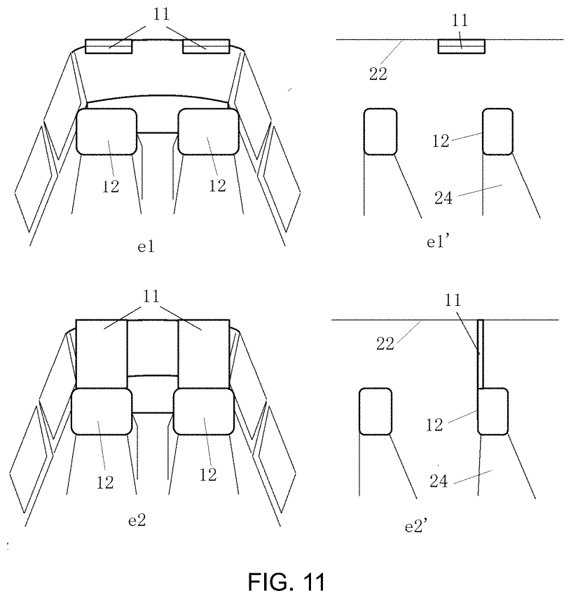

As shown in FIG. 11, FIG. 11 is a schematic structural view showing a vehicle-mounted display device in an automobile according to a third embodiment of the present disclosure. In FIG. 11, reference numbers e1 to e2 are front views of the vehicle-mounted display device in the automobile, and reference numbers e1′ to e4′ are side views of the vehicle-mounted display device in the automobile. Different from the first embodiment and the second embodiment, in a rear seat of the third embodiment, the display screen assembly may be formed by the first display screen 11 attached to the roof 22 and the second display screen 12 attached to a backside of the seat 24. Specifically, the second display screen 12 is attached to the backside of the seat 24, and the first display screen 11 is attached to a side of the roof 22 corresponding to the second display screen 12. The first display screen 11 is configured to form the display screen assembly with the second display screen 12 after being expanded.

In the present disclosure, a flexible and foldable display screen is applied to an automobile, which can significantly reduce space occupied by a display device. As a result, other devices in the automobile may have more space to be arranged. Moreover, the vehicle-mounted display device of the present disclosure may also be a sun visor or a rearview mirror in the automobile, which further conserves space. The flexible and foldable display screen has advantages such as lightweight and small volume. The flexible and foldable display screen can connect with other display devices in the automobile to form a display screen assembly with a large display area, thereby making arrangement of the vehicle-mounted display device more flexible and convenient.

The present disclosure further provides an automobile having the above vehicle-mounted display device.

To sum up, the present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

What is claimed is:

1. A vehicle-mounted display device, comprising a first display screen and a second display screen which are disposed individually and correspondingly;
wherein the vehicle-mounted display device is attached to an automobile cabin, and at least the first display screen is a flexible and foldable display screen;
wherein the first display screen comprises a bending section and two non-bending sections disposed at two sides of the bending section, one of the two non-bending sections is attached to the automobile cabin, and the other of the two non-bending sections is configured to fold or expand the first display screen along the bending section; and
wherein the first display screen is configured to connect with the second display screen to form a display screen assembly after being expanded.

2. The vehicle-mounted display device of claim 1, wherein the first display screen comprises a protective housing and a display panel disposed in the protective housing, each end of the two non-bending sections of the first display screen away from the bending section is provided with a reel disposed in the protective housing, two ends of the reel are attached to the protective housing, the display panel comprises an extended section, and the reel is configured to retract or expand the extended section of the display panel.

3. The vehicle-mounted display device of claim 2, wherein an elastic member is further disposed in the protective housing, and an end of the elastic member is connected to the extended section of the display panel.

4. The vehicle-mounted display device of claim 2, wherein the protective housing comprises two rigid sections corresponding to the two non-bending sections and a flexible section corresponding to the bending section, each end of the two rigid sections away from the flexible section is provided with a rigid extended section, at least a portion of the rigid extended section is embedded in the rigid section, and the reel is attached to the rigid extended section and is moved along the rigid extended section relative to a direction parallel to a plane on which the rigid section is disposed to drive the reel to rotate.

5. The vehicle-mounted display device of claim 4, wherein the rigid extended section is connected to the rigid section by a slide rail, and the protective housing is provided with a lock;
wherein when the rigid extended section is moved along the slide rail, the lock is opened; and
wherein after the rigid extended section is moved to a predetermined distance, the lock is closed.

6. The vehicle-mounted display device of claim 1, wherein the automobile cabin comprises a roof, a windshield, a center console, a sun visor, and a rear view mirror, the second display screen is attached to the center console, the first display screen is attached to a side of the roof near the windshield and corresponding to the second display screen, and the first display screen is configured to form the display screen assembly with the second display screen after being expanded.

7. The vehicle-mounted display device of claim 6, wherein the sun visor and/or the rear view mirror is the first display screen.

8. The vehicle-mounted display device of claim 6, wherein the automobile cabin further comprises a seat, the second display screen is attached to a backside of the seat, the first display screen is attached to a side of the roof corresponding to the second display screen, and the first display screen is configured to form the display screen assembly with the second display screen after being expanded.

9. An automobile, comprising the vehicle-mounted display device of claim

10. A vehicle-mounted display device, comprising a first display screen and a second display screen which are disposed individually and correspondingly;
wherein the vehicle-mounted display device is disposed in and attached to an automobile cabin, and at least the first display screen is a flexible and foldable display screen;
wherein the first display screen comprises a bending section and two non-bending sections disposed at two sides of the bending section, one of the two non-bending sections is attached to the automobile cabin, and the other of the two non-bending sections is configured to fold or expand the first display screen along the bending section; and
wherein at least one first display screen is configured to connect with at least one second display screen to form a display screen assembly after being expanded, and a periphery of one of the two non-bending sections configured to rotationally expand the first display screen is used to connect with a periphery of the second display screen near the first display screen to form the display screen assembly.

11. The vehicle-mounted display device of claim 10, wherein the first display screen comprises a protective housing and a display panel disposed in the protective housing, each end of the two non-bending sections of the first display screen away from the bending section is provided with a reel disposed in the protective housing, two ends of the reel are attached to the protective housing, the display panel comprises an extended section, and the reel is configured to retract or expand the extended section of the display panel.

12. The vehicle-mounted display device of claim 11, wherein an elastic member is further disposed in the protective housing, and an end of the elastic member is connected to the extended section of the display panel.

13. The vehicle-mounted display device of claim 11, wherein the protective housing comprises two rigid sections corresponding to the two non-bending sections and a flexible section corresponding to the bending section, each end of the two rigid sections away from the flexible section is provided with a rigid extended section, at least a portion of the rigid extended section is embedded in the rigid section, and the reel is attached to the rigid extended section and is moved along the rigid extended section relative to a direction parallel to a plane on which the rigid section is disposed to drive the reel to rotate.

14. The vehicle-mounted display device of claim 13, wherein the rigid extended section is connected to the rigid section by a slide rail, and the protective housing is provided with a lock;
wherein when the rigid extended section is moved along the slide rail, the lock is opened; and
wherein after the rigid extended section is moved to a predetermined distance, the lock is closed.

15. The vehicle-mounted display device of claim 10, wherein the automobile cabin comprises a roof, a windshield, a center console, a sun visor, and a rear view mirror, the second display screen is attached to the center console, the first display screen is attached to a side of the roof near the windshield and corresponding to the second display screen, and the first display screen is configured to form the display screen assembly with the second display screen after being expanded.

16. The vehicle-mounted display device of claim 15, wherein the sun visor and/or the rear view mirror is the first display screen.

17. The vehicle-mounted display device of claim 15, wherein the automobile cabin further comprises a seat, the second display screen is attached to a backside of the seat, the first display screen is attached to a side of the roof corresponding to the second display screen, and the first display screen is configured to form the display screen assembly with the second display screen after being expanded.
